(19) United States
(12) Patent Application Publication
(10) Pub. No.: US 2004/0027038 A1
(43) Pub. Date: Feb. 12, 2004

(54) System and method for cutting a furniture component to size and marking joint locations thereon

(75) Inventors: Robert Gaesser, Dale, IN (US); Kenneth J. Susnjara, Birdseye, IN (US)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: THERMWOOD CORPORATION, Dale, IN (US)

(21) Appl. No.: 10/216,440

(22) Filed: Aug. 12, 2002

(51) Int. Cl. B26D 7/06; B26D 7/02

(52) U.S. Cl. 312/294; 83/23; 83/452

(57) ABSTRACT

The present invention is an apparatus and a method of processing a workpiece on a worktable. Once the workpiece is properly loaded on the worktable, a moveable workpiece locator can either manually or automatically direct the workpiece to a predetermine location on the worktable so that a demarcation can be impressed by a marking disk on a predetermined location on the workpiece and the workpiece can be automatically cut to a predetermined length.

### FIELD OF THE INVENTION

The present invention relates to the production of furniture, in particular face-frame components for built-in household cabinetry.

### BACKGROUND OF THE INVENTION

The cabinetmaking industry makes use of an extensive array of construction methods and techniques. Of all the available designs and construction techniques, the basic face frame style of cabinetry remains perhaps the most widely utilized in the cabinet industry. In face frame construction, a framework of solid wood is fabricated and attached to the open front of the basic cabinet box, which is generally made of either plywood or some type of composite wood product. In addition to becoming a major part of the cabinet structure, the face frame, in conjunction with the doors and drawers, forms a solid wood front for the cabinet box. The face frame of the cabinet is constructed using two basic components, stiles that form the vertical members of the frame and rails, which form the horizontal members. Stiles and rails are fastened together utilizing a variety of methods. The mortise and tenon joint and the pocket-screw joint are two of the more popular joints in use today. To form the mortise and tenon joint, a pocket or mortise of a predetermined size is machined into the stile member of the face frame in a predetermined location. A tongue or tenon, which is adapted to fit snuggly into the mortise, is formed onto the end of the rail member by removing material, either by sawing or machining. An exploded view of such a joint is depicted in FIG. 2.

Traditionally, the mortise and tenon joint is produced using the most basic of hand tools including, saws, scribes, and one or more special chisels. A cabinetmaker first cuts the tenon onto the end of a rail by measuring and marking the material with a scribe, and then sawing away the unwanted material with a tenon saw. A mortise-marking gage is then adjusted to match the exact width and position of the tenon. The dimensions of the mortise is transferred to the style by aligning the pieces perpendicularly, and then marking the location by scribing two lines onto the edge of the style, guided by the sides of the tenon. The aforementioned gage is used to mark the width and exact location of the mortise onto the style. The mortise is generally cut by drilling several pilot holes, then carefully gouging out material within the scribed lines, using one or more special chisels. The aforementioned, lengthy process is still in limited use today, primarily by traditional and period furniture makers.

The art of mortise and tenon joinery has made significant advancements throughout the years. Large, dedicated machines can now rapidly produce tenons simultaneously on both ends of a rail at the rate of several thousand per day. Mortises can be produced at a similar rate utilizing dedicated machinery. While the aforementioned machinery is only practical for producing very large quantities of the same exact components, there are smaller, less expensive, and somewhat less complex mortise and tenon cutting machines available. Such machines are in frequent use by small independent cabinet companies, which comprise a large portion of the cabinetmaking industry.

The pocket-screw joint comprises a simple joint, joining two intersecting members by inserting one or more screws at an angle through the back side of one member into the adjoining member in such a manner as to conceal the joint from frontal viewing. An example of a pocket screw joint is illustrated in both a perspective and a section view in FIGS. 7a and 7b. The pocket screw joint is produced by first determining and marking the location at which two frame members will intersect. Next, the stile 701 and rail 702 are placed together with a first member disposed perpendicular to a second member in the normal assembled position. A special drill-guiding clamp fixture is attached to the concealed side of the joint, clamping both workpieces into position. The fixture generally has two guide-holes through which a drill bit may be guided at a predetermined angle, directly through the perpendicular member and into the second member. The drill bit is of a stepped design providing two distinct diameters, the first diameter forming a pilot hole into which a screw is fastened, with the second diameter forming a pocket in the upper end of the hole of sufficient depth to conceal the screw head below the surface 703. The drill bit is of sufficient length to drill through the first member and into the second member to a sufficient depth to securely accommodate a screw 704.

Although the pocket screw joint is relatively new, there are a number of devices in common use for forming the aforementioned pocket and pilot holes; these range from the simple fixture described above to more elaborate devices that may be pneumatically operated and provide a somewhat automated approach. In either case, in order to obtain satisfactory results, the material must be measured and marked in the exact position where the two members are to intersect.

The assimilation into the production process of computer numeric controlled (CNC) machinery and specialized cabinet-design software systems has given rise to perhaps the most significant advancement in the field of custom cabinet manufacturing. Advanced software systems have made it possible to design cabinets efficiently in a user-friendly environment, providing not only the basic design of the finished cabinet, but also the code programs necessary for producing all of the basic components of the cabinet on a CNC machine. However, the special fixtures and clamps required to produce face-frame components consume a considerable amount of machine space, thus resulting in a general deterioration of machine adaptability. Additionally, a considerable amount of both time and skill are required for accurately fastening and clamping components between program cycles, and the operator remains idle during the automatic cutting cycle of the machine; this time can vary from less than one minute to several minutes in duration. Similarly, there is no practical method for locating components onto the worktable for pocket-screw joints. Consequently, while the CNC machine represents a great advancement in cabinet production technology, it is still more practical to utilize separate, dedicated machinery for processing the required mortise and tenon joints as well as pocket screw joints; unfortunately this results in the relinquishing of a valuable aspect of advanced cabinet design capability.

A typical operation would utilize a cut-off saw with an automatically-indexing work stop for cutting stock to length, while separate machines are utilized for processing the required joints.

Since tenons are machined in essentially the same location on the end of each style or rail, there are few variables involved in their fabrication. While the size of the tenon is a variable, cabinetmakers predominantly tend to standardize their cabinet designs around one tenon size. Likewise, the width and thickness of the rail material is generally standardized. Because of these factors, it is possible for cabinetmakers to utilize a dedicated tenon-cutting machine that requires very infrequent set-up adjustments.

The mortise, in contrast, presents a completely different situation. When a mortise occurs at the end of a style or rail, such as is depicted in FIG. 8a, it is a relatively simple process to place the component against a fixed stop for cutting a mortise into the material. This is because in a corner joint, the mortise will always occur in the same location on the stock. However, depending on factors such as the number and size of drawers in a given cabinet, among others, the location in which a particular rail member intersects a style is oftentimes a variable. As best illustrated in FIG. 8b, such a complex face frame may comprise one or more middle rails 806,807, and 808, in addition to end rails 801 and 802 situated between stiles 803 and 804. It is thus necessary to provide a means for accurately positioning components for each mortising operation. Because of these variables, mortising machines as used in the custom cabinet industry tend to be relatively complex, stand-alone machines. There are a number of machines available on the market, which will produce both mortises and tenons. The cost and complexity of such machinery invariably coincides with the degree of automation and versatility that is imparted into the production process because of its use. It is difficult to justify such machinery in small to medium sized cabinet operations, since the value of such dedicated machinery is based upon the machine's ability to rapidly produce large quantities of the same component.

Conversely, the pocket screw joint also presents a problem. As a result of precise positioning requirements, cabinetmakers using this type of joint generally collect a vast array of special marking templates, each designated for marking specific cabinet configurations. Constructing and maintaining such templates, as well as selecting the proper template for a specific operation can consume an inordinate amount of time and resources.

Another problem that plagues cabinet shop operators is the cost of quality lumber. Lumber is graded based on the number of surface defects within a given length. Generally speaking, in order to qualify as “select” grade, a board must be defect free for at least eight feet. The lumber between the defects in a given board of the lesser grade is generally as good as the lumber in the defect-free “select” grade. However, the majority of cabinet shop operators tend to buy the more expensive “select” grade of lumber. Their reasoning for this is that in order to eliminate defects such as knots, a great deal of time must be utilized cutting boards into various lengths to eliminate defects, and then sorting and marking the various lengths for future use. More often than not, this is more expensive than purchasing the higher grade of lumber, due to the amount of labor and wasted lumber involved.

Based on the foregoing, it stands to reason that the ideal production process for custom cabinets would utilize CNC machinery for nested-based flat panel processing while face frame component fabrication is carried out simultaneously on separate equipment, preferably with minimal operator intervention. A system providing for the optimization and use of lesser grade lumber would be likewise desirable. In the ideal situation, CNC program codes, produced through a cabinet design software system, would be utilized to the fullest possible extent for cutting stock to length and processing all of the required face frame joints.

### SUMMARY OF THE INVENTION

The present invention presents a clear improvement over conventional CNC cabinet manufacturing methods, particularly, in time utilization and the simplification of the face frame joint production process.

Utilizing operating code derived from a single cabinet design software system, the present invention provides a means for accurately cutting face-frame stock to length, then accurately positioning and marking the location of mortises or pocket joint intersections on a workpiece for further processing on a separate machine. Such an operation allows for the use of relatively inexpensive machinery, while taking advantage of computer-generated code for accurately positioning and marking stock. The present invention likewise provides for the use of lumber of a lesser than normal grade by allowing the operator to select the component of optimum length to fit between the end of the workpiece and the first defect.

It is an object of the present invention to provide an improvement in the production of furniture and cabinet systems.

A further object of the present invention is to decrease the amount of time required to produce cabinet and furniture components through simultaneous multiple tasking of operations.

It is yet a further object of the present invention to minimize operator intervention and reduce the level of skill required in the process of furniture fabrication.

It is yet a further object of the present invention to increase the efficiency of CNC cabinet production by enhancing the versatility of auxiliary machinery, utilizing code produced by a cabinet-design software system.

It is still a further object of present invention to provide a means for the utilization of lesser grade lumber in the production process. Further objects of the present invention will become apparent from the detailed description that follows.

### BRIEF DESCRIPTION OF THE DRAWING

FIG. 1 is a fragmentary perspective view of a Programmable-stop cut-off saw station, specially adapted for cutting stock to length and for marking a workpiece for subsequent mortise cutting or assembly operations.

FIG. 2 is an exploded perspective view of a mortise and tenon joint.

FIG. 3 depicts an example of a label, intended for attachment to a workpiece, for identifying purposes.

FIG. 4 is a cutaway view depicting a pneumatically actuated marking device.

FIG. 5 is a flow chart depicting the process of furniture component production utilizing a plurality of machines.

FIG. 6 is a perspective view of a mortise and tenon cutting machine.

FIGS. 7a and 7b depict an example of a pocket screw joint in both a section and a perspective view.

FIG. 8a depicts a perspective view of a basic face frame assembly with only a top and bottom rail member.

FIG. 8b depicts a perspective view of a complex face frame assembly with multiple cross rails.

### DESCRIPTION OF THE PREFERRED EMBODIMENTS

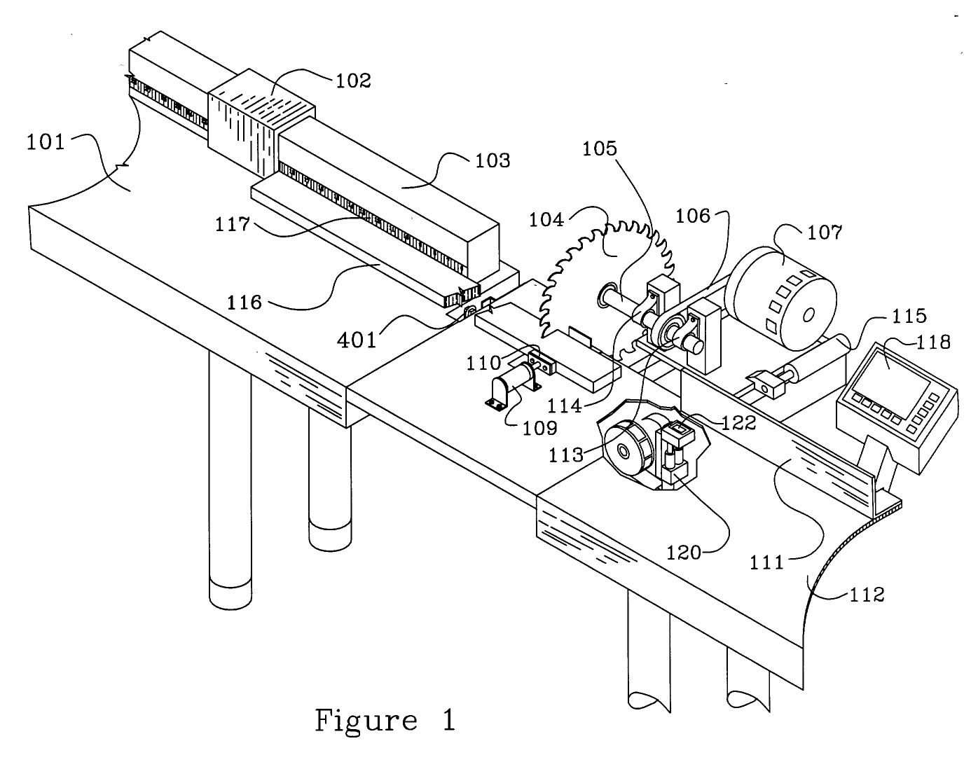

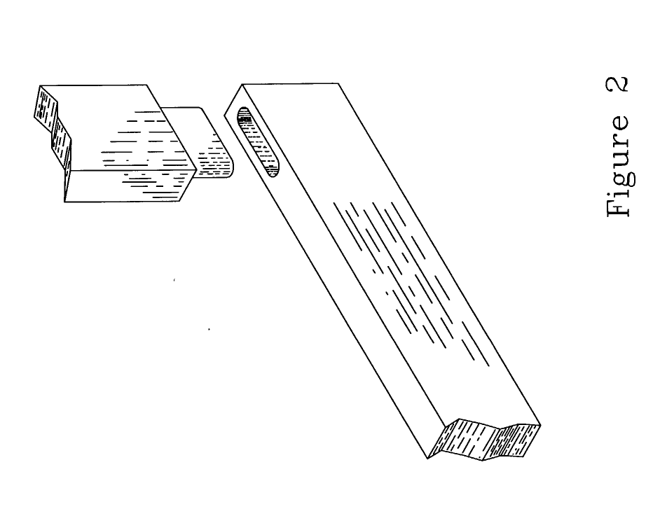

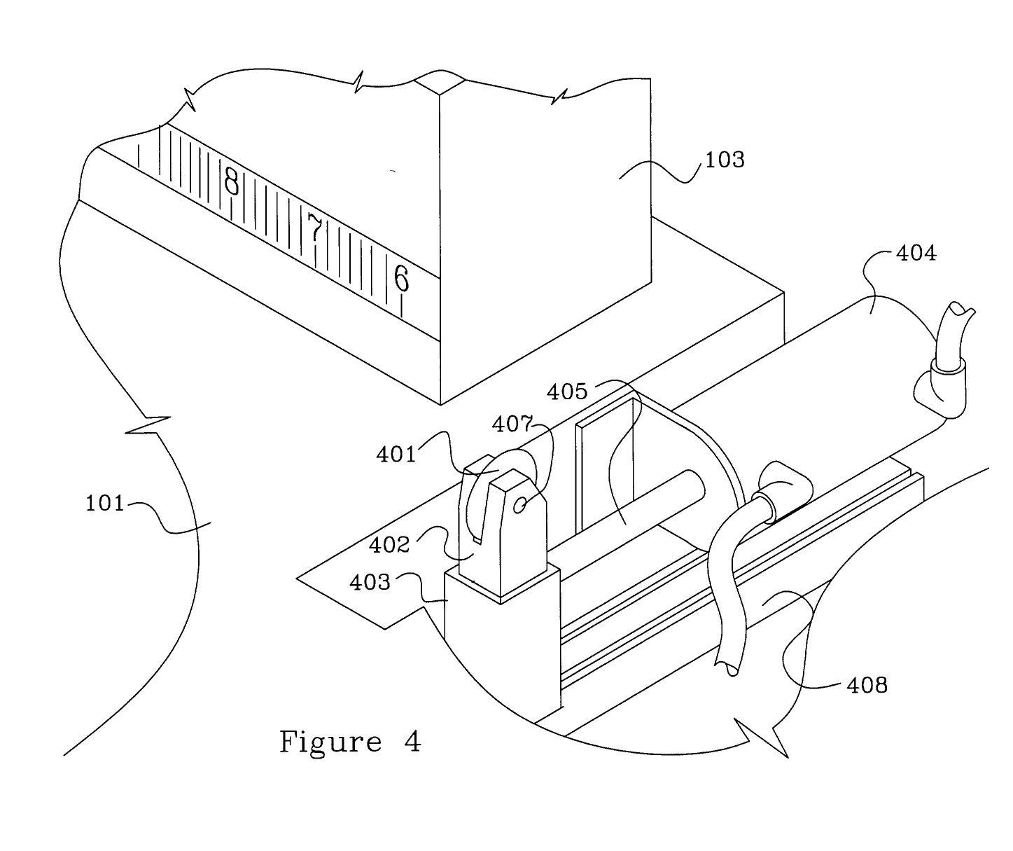

For a description of the mechanics of a programmable-stop, cut-off saw station; the applicant refers to FIG. 1. Said cut-off saw station comprises two elongated worktables 101 and 112 situated end-to-end, aligned in coplanar relationship, and separated by a distance suitable for locating a cut-off saw or other machining accessory. Each worktable, 101 and 112 is provided with a rigidly mounted backstop, correspondingly 103 and 111, suitable for locating a workpiece along the back of each table. Mounted near the bottom of backstop 103 is a graduated measuring scale 117. A movable workpiece-locating stop 102 is adapted to be displaced transversely along backstop 103 by a servomotor and drive-belt arrangement encased behind backstop 103. Locating stop 102 is adapted to be controllably moved into position along backstop 103 to facilitate accurate measurements for locating mortises or pocket-screw joints, or for cutting stock to the proper length. A first pneumatic activating cylinder 109 is mounted to worktable 101 and fitted with a pressure block with a pressure pad 110 for holding a workpiece in position for processing. Situated between worktables 101 and 112 is a cut-off saw comprising a motor 107 connected to a shaft 105 by means of a drive belt 106 and pulley arrangement. Said shaft is journaled in support bearings 113 and 114. A circular saw blade 104 is mounted on the end of shaft 105. A second pneumatic cylinder 115 provides a means for controllably displacing said cut-off saw to the full forward or aft position for cutting operations. Extending through a slot in worktable 101 is a pneumatically activated marking disk 401. Applicant now refers to FIG. 4 for a detailed description of said marking device. Referring to FIG. 4, there is illustrated a fragmented cut-away view of a pneumatically activated marking device. Said device comprises a pneumatic cylinder 404, disposed horizontally, mounted to the edge of worktable 101, and operatively connected to mounting block 403 by a cylinder rod 405. Mounting block 403 is adapted to traverse along a fixed rail 408. A yoke 402 is attached to mounting block 403. Mounted in the upper end of yoke 402 is a hardened steel disc serving as a marking disk 401, fastened in place by a pin 407 about which said disc is free to rotate. When a workpiece is placed upon worktable 101, controllably moved into position by workpiece locating stop 102, and clamped into place by pressure block and the pressure pad 110, cylinder 404 may be activated, Propelling mounting block 403 forward. Because said disk is disposed slightly above the worktable surface, said disk will cut into the surface of a workpiece when propelled forward, leaving a fine groove or mark in a predetermined location on the surface of said workpiece. Each of the displaceable components on the aforementioned workstation is adapted to be controlled through a single central controller 118 by codes derived from programs produced utilizing a cabinet design software system.

A workpiece 116 is placed onto worktable 101 against backstop 103, and then moved along said backstop until firm contact is made with workpiece locating stop 102. The operator then selects the mode to manually move workpiece-locating stop 102 until it pushes the workpiece just past the path of saw blade 104. Using the graduated measuring scale 117 on backstop 103, the operator visually checks for the location of any defect in the material, determining the length of material between the first defect and the saw path. Displayed on the screen of controller 118 is a list of different lengths of required components for a selected job. The operator may select from said list, the optimum component or combination of components to best utilize the available clear length, generally starting with the longest allowable length. After the operator selects a component, workpiece-locating stop 102 is directed to move a predetermined distance, based on the length of the selected component. When said locating stop reaches a predetermined extent of movement, pneumatic activating cylinder 109 is activated and pressure block and pressure pad 110 are directed to press firmly against the workpiece, holding it into position. The end of the workpiece is then trimmed, creating a specific reference point, determined by the location of workpiece-locating stop 102. If the stile is for use in a simple face frame with only a top and bottom rail, the workpiece-locating stop is directed to move forward and push said style into position for cutting to final length. Pneumatic activating cylinder 109 is activated, directing pressure block and the pressure pad 110 to press tightly against the workpiece 116, holding said workpiece into position as the cut-off saw is directed to advance forward, cutting said workpiece to the proper length. If however, the workpiece is to be used as a stile in a complex multiple-rail face frame, the workpiece-locating stop is directed to move forward, pushing the style into the proper position for marking the centerline location of the next intersecting joint. Pneumatic activating cylinder 109 is activated, directing pressure block and pressure pad 110 to press tightly against the workpiece, holding it into position. Marking disk 401 is then directed to move forward across the surface of the workpiece, making an impression in the surface of said workpiece in a predetermined location, in line with the center of the location for an intersecting joint. If joints for additional separating rails are required, the aforementioned procedure is repeated until all mortise centerlines have been marked. The workpiece is then advanced to the proper position for end-trimming, pneumatic activating cylinder 109 is activated, pressure block and pressure pad 110 are directed to press firmly against the workpiece, the cut-off saw is advanced, and the stile is trimmed to final length.

As clearly shown in FIG. 1 of the present invention, a printer 120 is installed on the underside of worktable 112 in the pathway of workpiece 116. Also shown is a label 122 imprinted thereon various information about the cut workpiece. The printer 120 may be for example Willett Model 263. When the cut workpiece is advanced due to the displacement caused by the moveable workpiece-locating stop in advancing any remaining workpiece, the cut workpiece will advanced toward the printer where any adhering material of label 122 which is facing upward will be adhered to the cut workpiece.

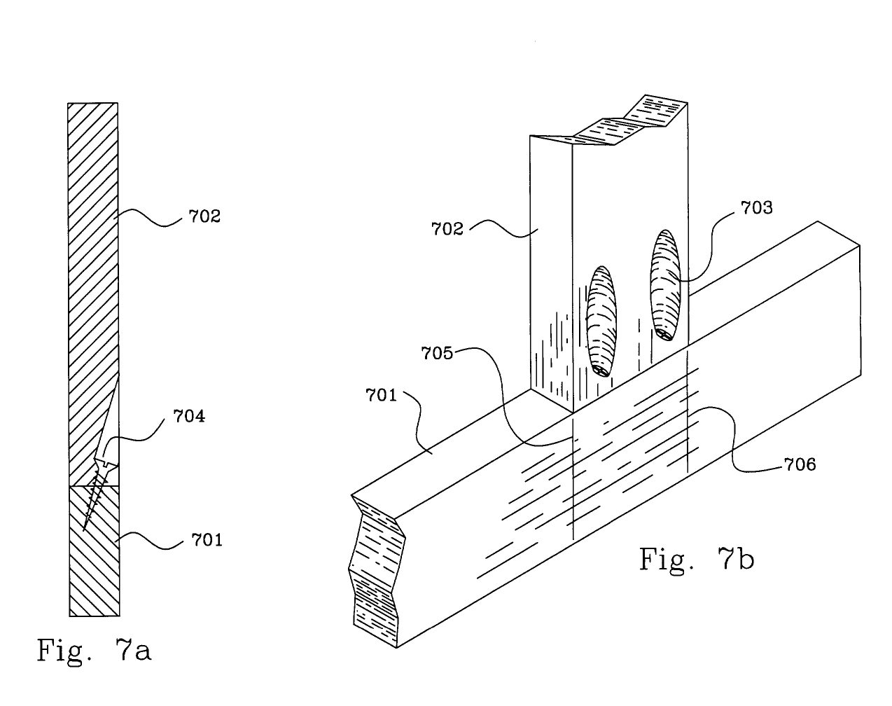

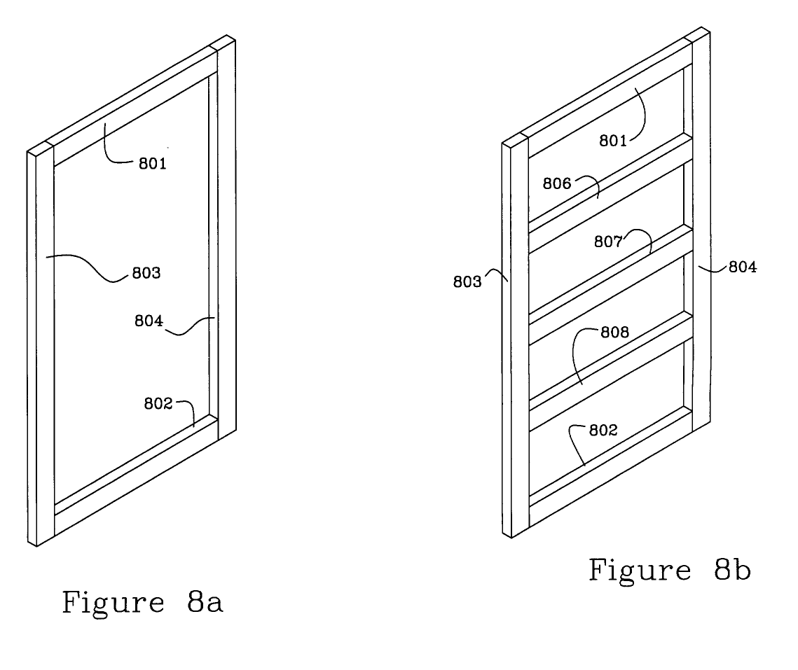

If pocket-screw construction is to be used for assembly, the aforementioned procedure is utilized for placing two marks in the position where the two components intersect as shown in FIG. 7, 705 and 706. The aforementioned cycle is repeated as often as is allowable for a given length of workpiece, then a new workpiece is loaded onto the machine and the process is again repeated.

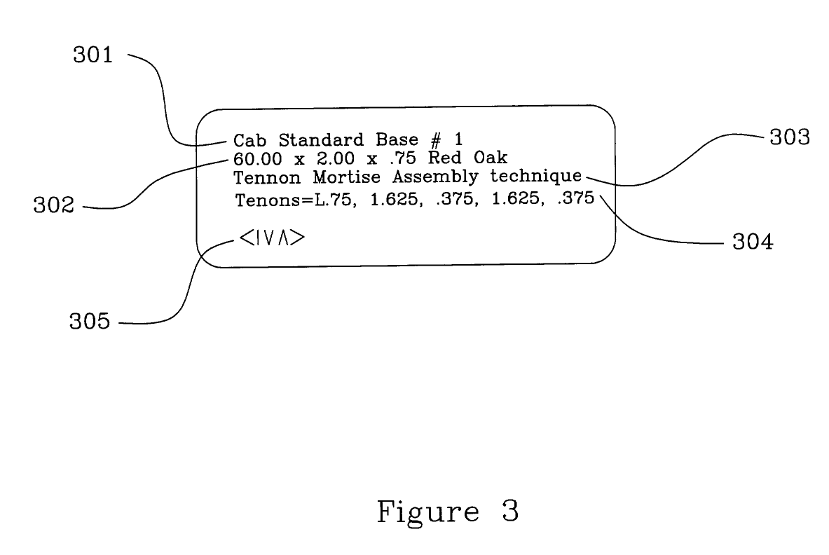

Referring to FIG. 3, information translated from the workpiece-processing program, including data such as the size of the component and the locations of various intersecting joints, is rendered in the form of a self-sticking label, for attachment to the workpiece. Such information is useful in identifying various aspects of said workpiece for future processing operations. On the label thus exemplified, the first line 301 indicates the cabinet for which the component is to be utilized. The second line 302 indicates the component's size and the type of material from which said component is fabricated. The third line 303 identifies the type of construction being utilized, while the fourth line 304 identifies the actual size of the tenons, including the length, the width, and the thickness. In the bottom left-hand corner of said label is an aggregation of common characters 305, representing the locations of various joints such as tenons and end-mortises, which are not inscribed in the material cut-off and marking operation.

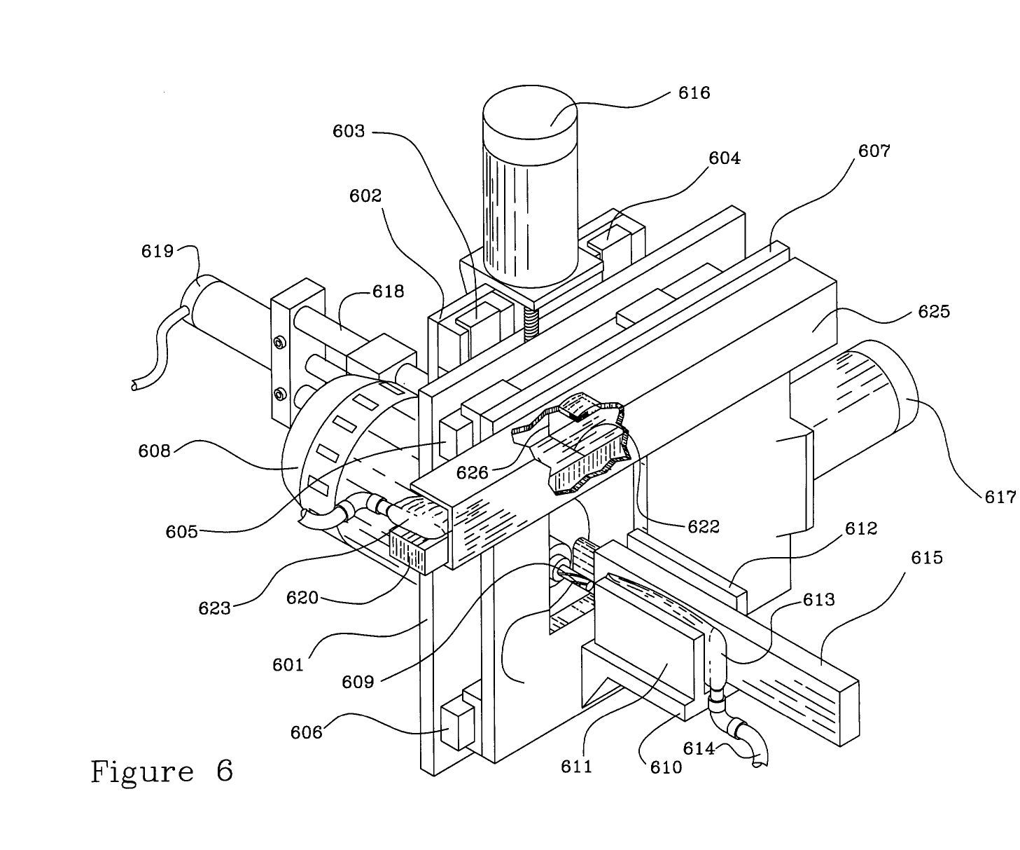

Applicant now refers to FIG. 6 for a brief description of a mortise and tenon cutting machine. FIG. 6 depicts a perspective view of the toolhead of a mortise and tenon cutting machine. Said machine comprises a basic mounting platform 601, the back face of which is provided with a pair of equally spaced, vertically disposed rails 603 and 604 on which toolhead support assembly 602 is mounted and displaceable along the z-axis by a feedscrew driven by servo motor 616. The front face of said mounting platform is provided with a vertically spaced, transversely disposed pair of rails 605 and 606 on which a worktable 607 is mounted and adapted to be displaced transversely along the x-axis by a feedscrew driven by servo motor 617. Servomotors 616 and 617 controlled and powered by single dedicated controller. Mounted on toolhead support assembly 602 is a horizontally disposed routing spindle 608, adapted to be displaced in the y-axis direction by means of a slide arrangement 618, powered by a pneumatic cylinder 619. A cutting tool 609 is mounted in said spindle and projects through an opening in mounting platform 601. Said cutting tool is disposed in a position whereby tool 609 will be at the proper depth when slide assembly 618 is fully extended. Disposed on the face of worktable 607 is a pneumatic workpiece holding clamp 610. Said holding clamp comprises two rigidly mounted upright members 611 and 612 between which is mounted an expandable, inflatable bladder 613, connected to an air supply 614. A workpiece 615 is positioned in clamp assembly 610 between bladder 613 and upright member 612. Compressed air is supplied to bladder 613, causing said bladder to expand, applying pressure against workpiece 615 in an amount sufficient for holding said workpiece securely for machining a tenon on the end thereof. Each of toolhead support assembly 602 and worktable 607 may be controllably moved along each of their respective axes in a coordinated manner, cutting a tenon on the end of workpiece 615. After said tenon has been satisfactorily cut, routing spindle 608 is retracted to the full back position, and toolhead support 606 is controllably moved to the uppermost position of travel. Air pressure is then released from bladder 613 and workpiece 615 is removed from workpiece holding clamp 610.

Mounted to the surface of worktable 607 is a pneumatic workpiece holding fixture 625 similar to the one described in the preceding paragraph. Cutting tool 609 is disposed in a predetermined neutral position, relative to the edge of access opening 626 in mounting platform 601. Mounted in the top of clamping fixture 625 is a glass viewing lens 621. When a workpiece 620 is placed into workpiece holding fixture 625, a line 622, inscribed on the surface of said workpiece in a previously described operation, is visually lined up with the edge of access opening 626. When the line on said workpiece and the edge of access opening 626 are precisely lined up, compressed air is supplied to bladder 623, securing said workpiece in place for cutting a mortise. Worktable 607 is directed to move a predetermined distance, positioning the centerline of tool 609 at a point exactly in the center of the location of the mortise. Routing spindle 608 is extended forward, plunging into workpiece 620. Worktables 607 and 602 are controllably moved in a coordinated manner, incising a mortise into workpiece 620, the center of which corresponds with the line inscribed on the surface of said workpiece. Routing spindle 608 is retracted to the back position, and air pressure is released from bladder 623. Another mark on said workpiece may be likewise lined up with the edge of access opening 626, and the previously described mortise-cutting operation thus repeated. When all of the required mortises have been cut into said workpiece, the air pressure is released from bladder 623 and the workpiece may be removed from workpiece holding fixture 625.

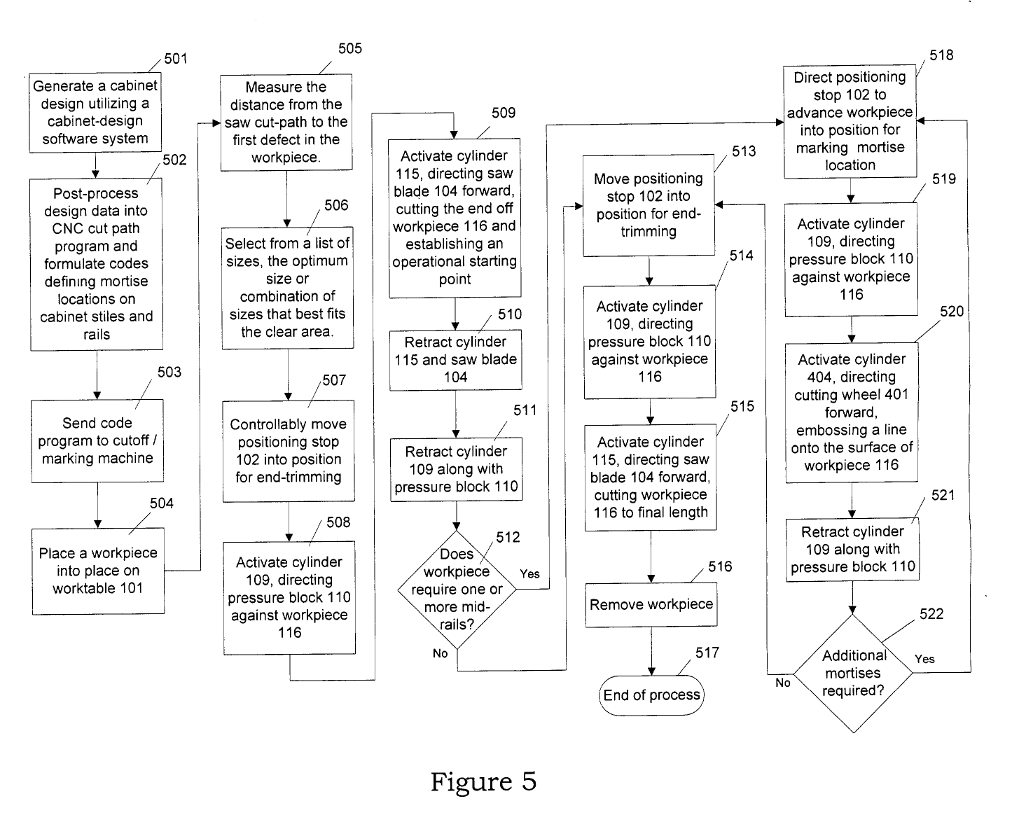

FIG. 5 is a flowchart that details the process flow for cutting to size and marking a wood furniture component. Referring to FIG. 5, a cabinet design is produced utilizing a cabinet-design software system 501. The design graphic is post-processed, generating cut-path and other relevant geometric data, including the lengths and joint centerline locations for various stile and rail components 502. The encoded length and joint centerline data is sent to the cutoff/marking machine 503. A workpiece is placed on the worktable of said machine, against the positioning stop 504. The operator measures the distance from the saw cut-path to the first defect in the workpiece 505. The operator selects the optimum size or combination of sizes that will best fit the clear area 506. The positioning stop is controllably moved into position for initial end-trimming 507. The pressure block control cylinder is activated, directing said pressure block against the workpiece 508. The saw is directed to move forward, cutting the end off and establishing the surface from which all subsequent operations will be referenced 509. The saw is retracted to the full aft position 510 along with the pressure block 511. If the cabinet component is to receive mortises in any location other than the ends 512, the positioning stop is directed to advance the workpiece into position for the next mortise 518, the pressure block is activated against the workpiece 519, and the cutting wheel extended forward, inscribing a line in a predetermined location on the workpiece surface 520. The cutting wheel as well as the pressure block is retracted 521. If additional mortises are required, steps 516 through 519 are repeated for each mortise. If no additional mortises are required, or if the workpiece requires mortises only in the end locations, the positioning stop advances the workpiece forward into the end-trimming position 511. The pressure block is activated against the workpiece 514, the saw is propelled forward, and the work piece is trimmed to final length 515. The workpiece is removed 514 and the process is completed 517.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

I claim:

1. A machining station, comprising:
a controller;
a worktable with a back stop;
a moveable workpiece locator mounted on the back stop;
a saw arranged in a cutting position adjacent the worktable;
a pressure lock with a pressure pad;
wherein a workpiece loaded against the back stop, the moveable workpiece locator and the worktable is automatically fed by the moveable workpiece locator into a predetermined position to be secured by the pressure lock and the pressure pad and the workpiece is automatically cut by the saw into a finished workpiece and a remaining workpiece.

2. The machining station of claim 1, wherein the moveable workpiece locator is actuated by a servomotor controlled by the controller.

3. The machining station of claim 1, wherein a referencing scale is attached to the back stop.

4. The machining station of claim 3, wherein the referencing scale is calibrated to be in accord to a program run by the controller.

5. The machining station of claim 1, wherein the pressure lock is actuated by one of a pneumatic pump and an electric motor.

6. The machining station of claim 5, wherein said one of the pneumatic pump and electric motor is controlled by said controller.

7. The machining station of claim 1, wherein an angle of said cut on the workpiece is in a range from more than 0 degree to less than 180 degrees relative to an edge of the workpiece.

8. The machining station of claim 1, wherein the saw is controlled by said controller.

9. The machining station of claim 1, wherein the pressure lock automatically releases the finished workpiece.

10. The machining station of claim 9, wherein the workpiece locator automatically feeds the remaining workpiece into the predetermined position to be secured by the pressure lock and the pressure pad for a subsequent cut by the saw.

11. The machining station of claim 9, wherein the pressure lock releases said finished workpiece and is displaced away from the saw when the remaining workpiece is automatically fed by the moveable workpiece locator.

12. The machining station of claim 1, wherein a marking disk is arranged underneath a top surface of the worktable and a sharp edge of the marking disk protrudes above the top surface.

13. The machining station of claim 11, wherein the marking disk is actuated by one of a pneumatic cylinder and an electric motor to impress at least one demarcation at a predetermined location of the finished workpiece.

14. The machining station of claim 12, wherein the at least one demarcation provides a reference for producing a mortise on the finished workpiece.

15. The machining station of claim 12, wherein the at least one demarcation provides a reference for producing a tenon on the finished workpiece.

16. The machining station of claim 12, wherein the at least one demarcation provides a reference for producing at least one pocket on the finished workpiece.

17. The machining station of claim 12, wherein said one of the pneumatic cylinder and the electric motor is controlled by the controller.

18. The machining station of claim 10, wherein a label is automatically adhered to the finished workpiece as it is displaced away from the saw.

19. The machining station of claim 11, wherein the label is printed with one of a workpiece purpose identifier, a size of the workpiece, a type of the workpiece, a location of a tenon, a location of a mortise, a size of a tenon, a size of a mortise and a type of construction.

20. The machining station of claim 12, wherein information printed on the label is provided by the controller.

21. The machining station of claim 1, wherein a printer is installed on the underside of the worktable.

22. A method of processing a workpiece on a worktable, comprising a plurality of steps of:
loading the workpiece on the worktable;
feeding the workpiece to a predetermined position;
securing the workpiece on the worktable at the predetermined position;
impressing at least one demarcation on the workpiece;
cutting the workpiece into a finished workpiece and a remaining workpiece wherein the at least one demarcation resides on the finished workpiece.

23. The method of claim 22, wherein the workpiece is loaded against a back stop and a moveable workpiece locator.

24. The method of claim 22, wherein the workpiece is fed by the moveable workpiece locator.

25. The method of claim 24, wherein the moveable workpiece locator is actuated by one of a pneumatic cylinder and an electric motor.

26. The method of claim 25, wherein the one of the pneumatic cylinder and the electric motor is controlled by a controller.

27. The method of claim 22, wherein the workpiece is secured to the worktable by a pressure block and a pressure pad.

28. The method of claim 27, wherein the pressure block is controlled by one of a pneumatic cylinder and an electric motor.

29. The method of claim 28, wherein said one of the pneumatic cylinder and the electric motor is controlled by a controller.

30. The method of claim 22, wherein the at least one demarcation is impressed by a marking disk mounted underneath the worktable and an edge of the marking disk protrudes above a surface of the worktable.

31. The method of claim 30, wherein the at least one demarcation provides a reference for producing a mortise on the finished workpiece.

32. The method of claim 30, wherein the at least one demarcation provides a reference for producing a tenon on the finished workpiece.

33. The method of claim 30, wherein the at least one demarcation provides a reference for producing a pocket on the finished workpiece.

34. The method of claim 30, wherein the marking disk is actuated by one of a pneumatic cylinder and an electric motor.

35. The method of claim 22, wherein an angle of the cut is in a range between more than 0 degree to less than 180 degrees relative to an edge of the workpiece.

36. The method of claim 22, further comprising a step of adhering a label on the finished workpiece.

37. The method of claim 36, wherein the label is printed with one of a workpiece purpose identifier, a size of the workpiece, a type of the workpiece, a location of a tenon, a location of a mortise, a size of a tenon, a size of a mortise and a type of construction.

38. The method of claim 37, wherein information printed on the label is provided by a controller.

39. The method of claim 37, wherein a printer is installed on an underside of the worktable.

40. The method of claim 36, wherein the label is adhered on the finished workpiece as it is displaced on the worktable.

41. A machining station, comprising:
A controller;
a worktable with a back stop;
a moveable workpiece locator mounted on the back stop;
a saw arranged in a cutting position adjacent the worktable;
a pressure lock with a pressure pad;
a marking disk mounted underneath the worktable;
wherein a workpiece loaded against the back stop, the moveable workpiece locator and the worktable is automatically fed by the moveable workpiece locator into a predetermined position to be secured by the pressure lock and the pressure pad, the workpiece is automatically impressed with a demarcation by the marking disk and the workpiece is automatically cut by the saw into a finished workpiece and a remaining workpiece wherein the demarcation resides on the finished workpiece.
